(19) United States
(12) Patent Application Publication
(10) Pub. No.: US 2026/0148708 A1
(43) Pub. Date: May 28, 2026

(54) IMAGE DISPLAY METHOD, ELECTRONIC DEVICE, AND COMPUTER-READABLE STORAGE MEDIUM

(71) Applicant: Huawei Technologies Co., Ltd., Shenzhen (CN)

(72) Inventors: Yasuo Suzuki, Tokyo (JP); Zhilin Xiao, Dongguan (CN); Di Shang, Tokyo (JP); Jiawen Zhang, Shanghai (CN); Takeshi Ikeda, Tokyo (JP)

(21) Appl. No.: 19/456,179

(22) Filed: Jan. 22, 2026

Related U.S. Application Data
(63) Continuation of application No. PCT/CN2024/109636, filed on Aug. 2, 2024.

(30) Foreign Application Priority Data
Aug. 29, 2023 (CN) 202311102916.3
Sep. 11, 2023 (CN) 202311170363.5

(51) Int. Cl. G09G 3/34; G09G 3/3208; G09G 3/36; G09G 5/10

(52) U.S. Cl. CPC G09G 3/3406; G09G 3/3208; G09G 3/3607; G09G 5/10; G09G 2320/062; G09G 2320/0666; G09G 2360/144

(57) ABSTRACT

An image display method, and electronic device. The method includes obtaining a first image and a first environmental illumination, where the first image is an image currently displayed by the electronic device, and the first environmental illumination is an illumination of an environment in which the electronic device is currently located, determining a first image brightness corresponding to the first image, determining a first screen brightness corresponding to the electronic device based on the first environmental illumination and the first image brightness, adjusting a current screen brightness of the electronic device based on the first screen brightness, and displaying the first image based on the first screen brightness.

### CROSS-REFERENCE TO RELATED APPLICATIONS

This application a continuation of International Application No. PCT/CN 2024/109636, filed on Aug. 2, 2024, which claims priorities to Chinese Patent Application No. 202311102916.3, filed on Aug. 29, 2023 and Chinese Patent Application No. 202311170363.5, filed on Sep. 11, 2023. All of the aforementioned patent applications are hereby incorporated by reference in their entireties.

### TECHNICAL FIELD

This application pertains to the field of terminal technologies, and in particular, relates to an image display method, an electronic device, and a computer-readable storage medium.

### BACKGROUND

Electronic devices are used in a wide range of environments. For example, the electronic device may be used in a darkroom environment, or may be used in an outdoor sunlight environment. Display effect of the electronic device is generally affected by an environmental illumination. To ensure that the electronic device can clearly display content, currently, the electronic device may adaptively adjust a backlight brightness of the electronic device based on the environmental illumination. For example, when the electronic device is used in different environments, the electronic device may linearly increase or decrease the backlight brightness of the electronic device based on an environmental illumination of a current environment, so that content displayed on the electronic device can be clearly displayed. However, this manner of linearly increasing the backlight brightness causes inconsistent subjective feelings of a user viewing same content in different environments, affecting user experience.

### SUMMARY

Embodiments of this application provide an image display method, an electronic device, and a computer-readable storage medium, to resolve a problem that user experience is affected due to inconsistent subjective feelings of a user viewing same content in different environments.

According to a first aspect, an embodiment of this application provides an image display method, applied to an electronic device, and the method includes obtaining a first image and a first environmental illumination, where the first image is an image currently displayed by the electronic device, and the first environmental illumination is an illumination of an environment in which the electronic device is currently located, determining a first image brightness corresponding to the first image, determining, based on the first environmental illumination and the first image brightness, a first screen brightness corresponding to the electronic device, and adjusting a current screen brightness of the electronic device based on the first screen brightness, and displaying the first image based on the first screen brightness.

In the image display method provided above, the electronic device may adjust a screen brightness of the electronic device based on the first environmental illumination of the environment in which the electronic device is currently located and the first image currently displayed by the electronic device, so that subjective feelings of the user viewing same content (namely, the first image) are consistent in different environments, thereby improving user experience.

In an example, the electronic device may store a first correspondence between an image brightness and a screen brightness under different environmental illuminations.

Determining, based on the first environmental illumination and the first image brightness, the first screen brightness corresponding to the electronic device includes determining, based on the first environmental illumination, the first image brightness, and the first correspondence, the first screen brightness corresponding to the electronic device.

In the image display method provided in this implementation, the electronic device may store the environmental illumination and the first correspondence between the image brightness and the screen brightness. Therefore, the electronic device may determine the first screen brightness corresponding to the electronic device based on the first environmental illumination, the first image brightness, and the first correspondence. Optionally, the environmental illumination and the first correspondence between the image brightness and the screen brightness may be determined based on a light sensing characteristic of a human eye.

For example, the environmental illumination and the first correspondence between the image brightness and the screen brightness may be represented by using a curve.

In a possible implementation of the first aspect, the method further includes adjusting a color saturation of the first image based on the first environmental illumination.

In the image display method provided in this implementation, the electronic device may further adjust a color saturation of the first image based on the first environmental illumination, so that the color saturation of the first image displayed by the electronic device is the same in different environments. In this way, subjective feelings of the user viewing the first image are the same in different environments, and user experience is improved.

In an example, adjusting the color saturation of the first image based on the first environmental illumination includes determining, based on the first environmental illumination and a screen reflectance of the electronic device, a color compensation coefficient corresponding to the first image, and adjusting the color saturation of the first image based on the color compensation coefficient.

In the image display method provided in this example, the electronic device may determine, based on the first environmental illumination, a color compensation coefficient corresponding to the first image, and may adjust the color saturation of the first image based on the color compensation coefficient. For example, the electronic device may determine a final color saturation of the first image based on the color compensation coefficient and a current color saturation of the first image, and adjust the color saturation of the first image based on the final color saturation of the first image, to adjust the color saturation of the first image to the final color saturation.

For example, determining, based on the first environmental illumination and the screen reflectance of the electronic device, the color compensation coefficient corresponding to the first image includes determining, based on the first environmental illumination and the screen reflectance of the electronic device, a first screen color gamut corresponding to the electronic device, where the first screen color gamut is a screen color gamut corresponding to the electronic device under the first environmental illumination, and determining, based on the first screen color gamut and a second screen color gamut, the color compensation coefficient corresponding to the first image, where the second screen color gamut is a screen color gamut corresponding to the electronic device under a second environmental illumination.

In the image display method provided in this example, the electronic device may determine the color compensation coefficient corresponding to the first image based on the screen color gamut corresponding to the electronic device under the second environmental illumination and the screen color gamut corresponding to the electronic device under the first environmental illumination. The second environmental illumination and the first environmental illumination are illuminations of different environments, and the second environmental illumination may be an illumination of an environment in which the electronic device is located before a use environment of the electronic device is switched to a current environment. For example, when the use environment of the electronic device is switched from an environment A (for example, an indoor environment) to an environment B (for example, an outdoor environment), the first environmental illumination may be an illumination of the environment B, and the second environmental illumination may be an illumination of the environment A. That is, the electronic device may compensate for the color saturation of the first image based on the illumination of the environment in which the electronic device is located before the switching and the illumination of the environment in which the electronic device is currently located, to ensure that the user has consistent subjective feelings for the first image in different environments, thereby improving user experience.

For example, the electronic device stores a second correspondence between an environmental illumination, a screen reflectance, and a screen color gamut.

Determining, based on the first environmental illumination and the screen reflectance of the electronic device, the first screen color gamut corresponding to the electronic device includes determining, based on the first environmental illumination, the screen reflectance, and the second correspondence, the first screen color gamut corresponding to the electronic device.

In the image display method provided in this example, the electronic device may store the second correspondence between the environmental illumination, the screen reflectance, and the screen color gamut. Therefore, the electronic device may determine, based on the first environmental illumination (or the second environmental illumination), the screen reflectance of the electronic device, and the second correspondence, the first screen color gamut (or the second screen color gamut) corresponding to the electronic device, to determine attenuation statuses of the screen color gamut in different environments. In this way, the color compensation coefficient corresponding to the first image is determined.

Optionally, the second correspondence may be determined in advance by measuring impact of different environmental illuminations on the screen color gamut corresponding to the electronic device at different screen reflectances.

According to a second aspect, an embodiment of this application provides an image display method, applied to an electronic device, and the method includes obtaining a first environmental illumination, where the first environmental illumination is an illumination of an environment in which the electronic device is currently located, determining, based on the first environmental illumination and a screen reflectance of the electronic device, a color compensation coefficient corresponding to a currently displayed first image, and adjusting a color saturation of the first image based on the color compensation coefficient, and displaying the first image whose color saturation is adjusted.

In the image display method provided above, the electronic device may further adjust the color saturation of the first image based on the first environmental illumination and the screen reflectance of the electronic device, so that the color saturation of the first image displayed by the electronic device is the same in different environments. In this way, subjective feelings of the user viewing the first image are the same in different environments, and user experience is improved.

For example, determining, based on the first environmental illumination and the screen reflectance of the electronic device, the color compensation coefficient corresponding to the currently displayed first image includes determining, based on the first environmental illumination and the screen reflectance of the electronic device, a first screen color gamut corresponding to the electronic device, where the first screen color gamut is a screen color gamut corresponding to the electronic device under the first environmental illumination, and determining, based on the first screen color gamut and a second screen color gamut, the color compensation coefficient corresponding to the first image, where the second screen color gamut is a screen color gamut corresponding to the electronic device under a second environmental illumination.

Optionally, the electronic device stores a second correspondence between an environmental illumination, a screen reflectance, and a screen color gamut.

Determining, based on the first environmental illumination and the screen reflectance of the electronic device, the first screen color gamut corresponding to the electronic device includes determining, based on the first environmental illumination, the screen reflectance, and the second correspondence, the first screen color gamut corresponding to the electronic device.

In an example, the method may further include determining a first image brightness corresponding to the first image, determining, based on the first environmental illumination and the first image brightness, a first screen brightness corresponding to the electronic device, and adjusting a current screen brightness of the electronic device based on the first screen brightness, and displaying the first image whose color saturation is adjusted includes displaying, based on the first screen brightness, the first image whose color saturation is adjusted.

Optionally, the electronic device may store a first correspondence between an image brightness and a screen brightness under different environmental illuminations.

Determining, based on the first environmental illumination and the first image brightness, the first screen brightness corresponding to the electronic device includes determining, based on the first environmental illumination, the first image brightness, and the first correspondence, the first screen brightness corresponding to the electronic device.

According to a third aspect, an embodiment of this application provides an image display apparatus, used in an electronic device, where the apparatus includes an environmental illumination obtaining module, configured to obtain a first image and a first environmental illumination, where the first image is an image currently displayed by the electronic device, and the first environmental illumination is an illumination of an environment in which the electronic device is currently located, an image brightness determining module, configured to determine a first image brightness corresponding to the first image, a screen brightness determining module, configured to determine, based on the first environmental illumination and the first image brightness, a first screen brightness corresponding to the electronic device, and adjust a current screen brightness of the electronic device based on the first screen brightness, and an image display module, configured to display the first image based on the first screen brightness.

In an example, the electronic device may store a first correspondence between an image brightness and a screen brightness under different environmental illuminations.

The screen brightness determining module is specifically configured to determine, based on the first environmental illumination, the first image brightness, and the first correspondence, the first screen brightness corresponding to the electronic device.

In a possible implementation of the third aspect, the apparatus further includes a color saturation adjusting module, configured to adjust a color saturation of the first image based on the first environmental illumination.

In an example, the color saturation adjusting module may be specifically configured to determine, based on the first environmental illumination and a screen reflectance of the electronic device, a color compensation coefficient corresponding to the first image, and adjust the color saturation of the first image based on the color compensation coefficient.

For example, the color saturation adjusting module may be further configured to determine, based on the first environmental illumination, and the screen reflectance of the electronic device, a first screen color gamut corresponding to the electronic device, where the first screen color gamut is a screen color gamut corresponding to the electronic device under the first environmental illumination, and determine, based on the first screen color gamut and a second screen color gamut, a color compensation coefficient corresponding to the first image, where the second screen color gamut is a screen color gamut corresponding to the electronic device under the second environmental illumination.

For example, the electronic device stores a second correspondence between an environmental illumination, a screen reflectance, and a screen color gamut.

The color saturation adjusting module is further configured to determine, based on the first environmental illumination, the screen reflectance, and the second correspondence, the first screen color gamut corresponding to the electronic device.

According to a fourth aspect, an embodiment of this application provides an image display apparatus, used in an electronic device, where the apparatus includes an environmental illumination obtaining module, configured to obtain a first environmental illumination, where the first environmental illumination is an illumination of an environment in which the electronic device is currently located, a compensation coefficient determining module, configured to determine, based on the first environmental illumination and a screen reflectance of the electronic device, a color compensation coefficient corresponding to a currently displayed first image, and a color saturation adjusting module, configured to adjust a color saturation of the first image based on the color compensation coefficient, and display the first image whose color saturation is adjusted.

For example, the compensation coefficient determining module may be specifically configured to determine, based on the first environmental illumination, and the screen reflectance of the electronic device, a first screen color gamut corresponding to the electronic device, where the first screen color gamut is a screen color gamut corresponding to the electronic device under the first environmental illumination, and determine, based on the first screen color gamut and a second screen color gamut, a color compensation coefficient corresponding to the first image, where the second screen color gamut is a screen color gamut corresponding to the electronic device under the second environmental illumination.

Optionally, the electronic device stores a second correspondence between an environmental illumination, a screen reflectance, and a screen color gamut.

The compensation coefficient determining module is further configured to determine, based on the first environmental illumination, the screen reflectance, and the second correspondence, the first screen color gamut corresponding to the electronic device.

In an example, the apparatus may further include an image brightness determining module, configured to determine a first image brightness corresponding to the first image, a screen brightness determining module, configured to determine, based on the first environmental illumination and the first image brightness, a first screen brightness corresponding to the electronic device, and adjust a current screen brightness of the electronic device based on the first screen brightness, and the color saturation adjusting module, further configured to display, based on the first screen brightness, the first image whose color saturation is adjusted.

Optionally, the electronic device may store a first correspondence between an image brightness and a screen brightness under different environmental illuminations.

The screen brightness determining module is specifically configured to determine, based on the first environmental illumination, the first image brightness, and the first correspondence, the first screen brightness corresponding to the electronic device.

According to a fifth aspect, an embodiment of this application provides an electronic device, where the electronic device includes a photosensitive component, a processor, and a display, the photosensitive component is configured to obtain a first environmental illumination, where the first environmental illumination is an illumination of an environment in which the electronic device is currently located, the processor is configured to obtain a first image, where the first image is an image currently displayed by the electronic device, and determine a first image brightness corresponding to the first image, the processor is further configured to determine, based on the first environmental illumination and the first image brightness, a first screen brightness corresponding to the electronic device, and adjust a current screen brightness of the electronic device based on the first screen brightness, the processor is further configured to determine, based on the first environmental illumination and a screen reflectance of the electronic device, a color compensation coefficient corresponding to the first image, and adjust a color saturation of the first image based on the color compensation coefficient, and the display is configured to display, at the first screen brightness, the first image whose color saturation is adjusted.

In an example, the electronic device stores a first correspondence between an image brightness and a screen brightness under different environmental illuminations.

The processor is further configured to determine, based on the first environmental illumination, the first image brightness, and the first correspondence, the first screen brightness corresponding to the electronic device.

In another example, the processor is further configured to determine, based on the first environmental illumination, and the screen reflectance of the electronic device, a first screen color gamut corresponding to the electronic device, where the first screen color gamut is a screen color gamut corresponding to the electronic device under the first environmental illumination, and determine, based on the first screen color gamut and a second screen color gamut, a color compensation coefficient corresponding to the first image, where the second screen color gamut is a screen color gamut corresponding to the electronic device under the second environmental illumination.

Optionally, the electronic device stores a second correspondence between an environmental illumination, a screen reflectance, and a screen color gamut.

The processor is further configured to determine, based on the first environmental illumination, the screen reflectance, and the second correspondence, the first screen color gamut corresponding to the electronic device.

According to a sixth aspect, an embodiment of this application provides an electronic device, including a memory, a processor, and a computer program that is stored in the memory and that can be run on the processor. When the processor executes the computer program, the electronic device is enabled to implement the image display method in any one of the first aspect or the second aspect.

According to a seventh aspect, an embodiment of this application provides a computer-readable storage medium. The computer-readable storage medium stores a computer program. When the computer program is executed by a computer, the computer is enabled to implement the image display method in any one of the first aspect or the second aspect.

According to an eighth aspect, an embodiment of this application provides a computer program product. When the computer program product runs on an electronic device, the electronic device is enabled to perform the image display method in any one of the first aspect or the second aspect.

It may be understood that, for beneficial effects of the third aspect to the eighth aspect, reference may be made to related descriptions in the first aspect or the second aspect. Details are not described herein again.

### BRIEF DESCRIPTION OF THE DRAWINGS

FIG. 1 is a diagram of a structure of an electronic device according to an embodiment of this application;

FIG. 2 is a block diagram of a software structure of an electronic device according to an embodiment of this application;

FIG. 3 is a schematic flowchart of an image display method according to an embodiment of this application;

FIG. 4 is an example diagram of a first correspondence according to an embodiment of this application;

FIG. 5a is an example diagram of testing a screen color gamut according to an embodiment of this application;

FIG. 5b is an example diagram of a screen color gamut according to an embodiment of this application;

FIG. 6 is a schematic flowchart of an image display method according to another embodiment of this application; and

FIG. 7 is a diagram of a structure of an electronic device according to another embodiment of this application.

### DETAILED DESCRIPTION OF ILLUSTRATIVE EMBODIMENTS

It should be understood that the term “include”/“comprise” when used in the specification of this application and the appended claims indicates the presence of the described features, wholes, steps, operations, elements, and/or components, but does not preclude the presence or addition of one or more other features, wholes, steps, operations, elements, components, and/or collections thereof.

It should also be understood that the term “and/or” as used in the specification of this application and the appended claims refers to any combination of one or more of associated items and all possible combinations, and includes such combinations.

As used in the specification of this application and the appended claims, the term “if” may be interpreted as “when” or “once” or “in response to determining” or “in response to detecting” depending on the context. Similarly, the phrase “if it is determined” or “if [described condition or event] is detected” may be interpreted, depending on the context, to mean “once determined” or “in response to determining” or “once [described condition or event] is detected” or “in response to detecting [described condition or event]”.

In addition, in the description of the specification of this application and the appended claims, the terms “first”, “second”, “third”, and the like are merely used for distinguishing descriptions, but cannot be understood as indicating or implying relative importance.

Reference to “one embodiment” or “some embodiments” described in the specification of this application means that one or more embodiments of this application include a specific feature, structure, or characteristic described with reference to embodiments. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise specifically emphasized in another manner. The terms “include”, “have”, and their variants all mean “include but are not limited to”, unless otherwise specifically emphasized in another manner.

In addition, “a plurality of” mentioned in embodiments of this application should be interpreted as two or more.

Steps in an image display method provided in embodiments of this application are merely examples. Not all steps are mandatory steps, or not content in each piece of information or a message is mandatory. In a use process, the step or the content may be added or removed based on a requirement. In different embodiments, mutual reference is made to a same step or steps or messages having a same function in embodiments of this application.

A service scenario described in embodiments of this application is intended to describe the technical solutions in embodiments of this application more clearly, and does not constitute a limitation on the technical solutions provided in embodiments of this application. Persons of ordinary skill in the art may learn that, with evolution of a network architecture and emergence of a new service scenario, the technical solutions provided in embodiments of this application are also applicable to similar technical problems.

Electronic devices are used in a wide range of environments. For example, the electronic device may be used in a darkroom environment, or may be used in an outdoor sunlight environment. Display effect of the electronic device is generally affected by an environmental illumination. To ensure that the electronic device can clearly display content, currently, the electronic device may adaptively adjust a backlight brightness of the electronic device based on the environmental illumination. For example, when the electronic device is used in different environments, the electronic device may linearly increase or decrease the backlight brightness of the electronic device based on an environmental illumination of a current environment, so that content displayed on the electronic device can be clearly displayed. However, this manner of linearly increasing the backlight brightness causes inconsistent subjective feelings of a user viewing same content in different environments, affecting user experience.

To resolve the foregoing problem, embodiments of this application provide an image display method, an electronic device, and a computer-readable storage medium. In the method, the electronic device may obtain a first image currently displayed by the electronic device and a first environmental illumination of an environment in which the electronic device is currently located, and determine a first image brightness corresponding to the first image. Subsequently, the electronic device may determine a first screen brightness corresponding to the electronic device based on the first environmental illumination and the first image brightness, and may adjust a current screen brightness of the electronic device based on the first screen brightness, to display the first image based on an adjusted screen brightness. In other words, in embodiments of this application, the electronic device may adjust a screen brightness of the electronic device based on the first environmental illumination of the environment in which the electronic device is currently located and the first image currently displayed by the electronic device, so that subjective feelings of a user viewing same content (namely, the first image) are consistent in different environments, thereby improving user experience and having strong usability and practicability.

In embodiments of this application, the electronic device may be an electronic device with a display, like a mobile phone, a tablet computer, a wearable device, a smart television, a smart screen, a vehicle-mounted device, a notebook computer, an ultra-mobile personal computer (UMPC), a netbook, a personal digital assistant (PDA), or a desktop computer. A specific type of the electronic device is not limited in embodiments of this application.

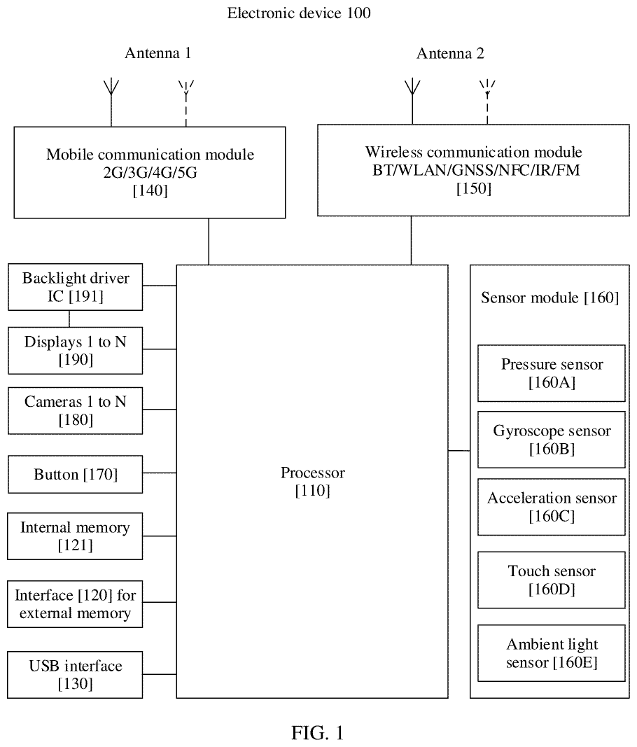

The following first describes the electronic device in embodiments of this application. FIG. 1 is a diagram of a structure of an electronic device 100.

The electronic device 100 may include a processor 110, an interface 120 for external memory, an internal memory 121, a universal serial bus (USB) interface 130, an antenna 1, an antenna 2, a mobile communication module 140, a wireless communication module 150, a sensor module 160, a button 170, a camera 180, a display 190, a backlight driver integrated circuit (IC) board 191, and the like. The sensor module 160 may include a pressure sensor 160A, a gyroscope sensor 160B, an acceleration sensor 160C, a touch sensor 160D, an ambient light sensor 160E, and the like.

It may be understood that the structure shown in embodiments of this application does not constitute a specific limitation on the electronic device 100. In some other embodiments of this application, the electronic device 100 may include more or fewer components than those shown in the figure, or a combination of a part of the components, or splits from a part of the components, or an arrangement of different components. The components shown in the figure may be implemented by hardware, software, or a combination of software and hardware.

The processor 110 may include one or more processing units. For example, the processor 110 may include an application processor (AP), a modem processor, a graphics processing unit (GPU), an image signal processor (ISP), a controller, a video codec, a digital signal processor (DSP), a baseband processor, a neural-network processing unit (NPU), and/or the like. Different processing units may be independent components, or may be integrated into one or more processors.

The controller may generate an operation control signal based on an instruction operation code and a time sequence signal, to complete control of instruction reading and instruction execution.

A memory may be further disposed in the processor 110, and is configured to store instructions and data. In some embodiments, the memory in the processor 110 is a cache memory. The memory may store instructions or data just used or cyclically used by the processor 110. If the processor 110 needs to use the instructions or the data again, the processor may directly invoke the instructions or the data from the memory. This avoids repeated access, reduces waiting time of the processor 110, and improves system efficiency.

In some embodiments, the processor 110 may include one or more interfaces. The interface may include an inter-integrated circuit (I2C) interface, an inter-integrated circuit sound (I2S) interface, a pulse code modulation (PCM) interface, a universal asynchronous receiver/transmitter (UART) interface, a mobile industry processor interface (MIPI), a general-purpose input/output (GPIO) interface, a subscriber identity module (SIM) interface, a universal serial bus (USB) interface, and/or the like.

The I2C interface is a two-way synchronization serial bus, and includes one serial data line (SDA) and one serial clock line (SCL). In some embodiments, the processor 110 may include a plurality of groups of I2C buses. The processor 110 may be separately coupled to the touch sensor 160D, a flash, the camera 180, and the like through different I2C bus interfaces. For example, the processor 110 may be coupled to the touch sensor 160D through the I2C interface, so that the processor 110 communicates with the touch sensor 160D through the I2C bus interface, to implement a touch function of the electronic device 100.

The MIPI interface may be configured to connect the processor 110 to peripheral devices such as the display 190 and the camera 180. The MIPI interface includes a camera serial interface (CSI), a display serial interface (DSI), and the like. In some embodiments, the processor 110 communicates with the camera 180 through the CSI interface, to implement a photographing function of the electronic device 100. The processor 110 communicates with the display 190 through the DSI interface, to implement a display function of the electronic device 100.

The GPIO interface may be configured by software. The GPIO interface may be configured as a control signal or a data signal. In some embodiments, the GPIO interface may be configured to connect the processor 110 to the camera 180, the display 190, the wireless communication module 150, the sensor module 160, or the like. The GPIO interface may be further configured as the I2C interface, the I2S interface, the UART interface, the MIPI interface, or the like.

The USB interface 130 is an interface that conforms to a USB standard specification, and may be specifically a mini USB interface, a micro USB interface, a USB Type-C interface, or the like. The USB interface 130 may be configured to connect to a charger to charge the electronic device 100, may be configured to transmit data between the electronic device 100 and a peripheral device, or may be configured to connect to a headset, to play audio through the headset. The interface may be further configured to connect to another electronic device, for example, an AR device.

It may be understood that an interface connection relationship between the modules shown in this embodiment of this application is merely an example for description, and does not constitute a structural limitation on the electronic device 100. In some other embodiments of this application, the electronic device 100 may alternatively use an interface connection manner different from that in the foregoing embodiment, or a combination of a plurality of interface connection manners.

A wireless communication function of the electronic device 100 may be implemented by using the antenna 1, the antenna 2, the mobile communication module 140, the wireless communication module 150, the modem processor, the baseband processor, and the like.

The antenna 1 and the antenna 2 are configured to transmit and receive an electromagnetic wave signal. Each antenna in the electronic device 100 may be configured to cover one or more communication frequency bands. Different antennas may be further reused, to improve antenna utilization. For example, the antenna 1 may be reused as a diversity antenna of a wireless local area network. In some other embodiments, the antenna may be used in combination with a tuning switch.

The mobile communication module 140 may provide a solution that is applied to the electronic device 100 and that includes wireless communication such as 2G/3G/4G/5G. The mobile communication module 140 may include at least one filter, a switch, a power amplifier, a low noise amplifier (LNA), and the like. The mobile communication module 140 may receive an electromagnetic wave through the antenna 1, perform processing such as filtering or amplification on the received electromagnetic wave, and transmit the electromagnetic wave to the modem processor for demodulation. The mobile communication module 140 may further amplify a signal modulated by the modem processor, and convert the signal into an electromagnetic wave for radiation through the antenna 1. In some embodiments, at least some functional modules of the mobile communication module 140 may be disposed in the processor 110. In some embodiments, at least some functional modules of the mobile communication module 140 may be disposed in a same component as at least some modules of the processor 110.

The modem processor may include a modulator and a demodulator. The modulator is configured to modulate a to-be-sent low-frequency baseband signal into a medium-high frequency signal. The demodulator is configured to demodulate a received electromagnetic wave signal into a low-frequency baseband signal. Then, the demodulator transmits the low-frequency baseband signal obtained through demodulation to the baseband processor for processing. The low-frequency baseband signal is processed by the baseband processor and then transmitted to the application processor. The application processor displays an image or a video through the display 190. In some embodiments, the modem processor may be an independent device. In some other embodiments, the modem processor may be independent of the processor 110, and is disposed in a same device as the mobile communication module 140 or another functional module.

The wireless communication module 150 may provide a solution that is applied to the electronic device 100 and that includes wireless communication such as a wireless local area network (WLAN) (for example, a Wi-Fi network), Bluetooth (BT), a global navigation satellite system (GNSS), frequency modulation (FM), a near field communication (NFC) technology, and an infrared (infrared, IR) technology. The wireless communication module 150 may be one or more components integrating at least one communication processor module. The wireless communication module 150 receives an electromagnetic wave through the antenna 2, performs frequency modulation and filtering processing on an electromagnetic wave signal, and sends a processed signal to the processor 110. The wireless communication module 150 may further receive a to-be-sent signal from the processor 110, perform frequency modulation and amplification on the signal, and convert the signal into an electromagnetic wave through the antenna 2 for radiation.

In some embodiments, the antenna 1 of the electronic device 100 is coupled to the mobile communication module 140, and the antenna 2 is coupled to the wireless communication module 150, so that the electronic device 100 can communicate with a network and another device through a wireless communication technology. The wireless communication technology may include a global system for mobile communications (global system for mobile communications, GSM), a general packet radio service (GPRS), code division multiple access (CDMA), wideband code division multiple access (WCDMA), time-division code division multiple access (TD-SCDMA), long term evolution (LTE), BT, a GNSS, a WLAN, NFC, FM, an IR technology, and/or the like. The GNSS may include a global positioning system (GPS), a global navigation satellite system (GLONASS), a BeiDou navigation satellite system (BDS), a quasi-zenith satellite system (QZSS), and/or a satellite based augmentation system (SBAS).

The electronic device 100 implements a display function by using the GPU, the display 190, the application processor, and the like. The GPU is a microprocessor for image processing, and is connected to the display 190 and the application processor. The GPU is configured to perform mathematical and geometric computation, and render an image. The processor 110 may include one or more GPUs, which execute program instructions to generate or change display information.

The display 190 is configured to display an image, a video, and the like. The display 190 includes a display panel. The display panel may be a liquid crystal display (LCD), an organic light-emitting diode (OLED), an active-matrix organic light-emitting diode (AMOLED), a flexible light-emitting diode (FLED), a mini-LED, a micro-LED, a micro-OLED, a quantum dot light-emitting diode (QLED), or the like. In some embodiments, the electronic device 100 may include one or N displays 190, where N is a positive integer greater than 1.

The backlight driver IC 191 is configured to control a backlight brightness of the display 190. The backlight driver IC 191 is connected to the display 190. When the processor 110 adjusts the backlight brightness of the display 190, the processor 110 may convert an adjusted backlight brightness into data in a specific format and send the data to the backlight driver IC 191. After identifying the backlight brightness, the backlight driver IC 191 may control the backlight brightness of the display 190 to change, so that the backlight brightness of the display 190 is adjusted to the backlight brightness. The data in the specific format may be pulse width modulation (PWM).

The electronic device 100 may implement a photographing function by using the ISP, the camera 180, the video codec, the GPU, the display 190, the application processor, and the like.

The ISP is configured to process data fed back by the camera 180. For example, during photographing, a shutter is pressed, and light is transmitted to a photosensitive element of the camera through a lens. An optical signal is converted into an electrical signal, and the photosensitive element of the camera transmits the electrical signal to the ISP for processing, to convert the electrical signal into a visible image. The ISP may further perform algorithm optimization on noise, brightness, and complexion of the image. The ISP may further optimize parameters such as exposure and a color temperature of a photographing scenario. In some embodiments, the ISP may be disposed in the camera 180.

The camera 180 is configured to capture a static image or a video. An optical image of an object is generated through the lens, and is projected onto the photosensitive element. The photosensitive element may be a charge coupled device (CCD) or a complementary metal-oxide-semiconductor (CMOS) optoelectronic transistor. The light-sensitive element converts an optical signal into an electrical signal, and then transmits the electrical signal to the ISP to convert the electrical signal into a digital image signal. The ISP outputs the digital image signal to the DSP for processing. The DSP converts the digital image signal into an image signal in a standard format such as RGB or YUV. In some embodiments, the electronic device 100 may include one or N cameras 180, where N is a positive integer greater than 1.

The digital signal processor is configured to process a digital signal, and may process another digital signal in addition to the digital image signal. For example, when the electronic device 100 selects a frequency, the digital signal processor is configured to perform Fourier transformation on frequency energy.

The video codec is configured to compress or decompress a digital video. The electronic device 100 may support one or more video codecs. Therefore, the electronic device 100 may play or record videos in a plurality of coding formats, for example, moving picture experts group (MPEG) 1, MPEG 2, MPEG 3, and MPEG 4.

The NPU is a neural-network (neural-network, NN) computing processor, simulates a biological neural network structure such as a transmission mode between neurons in a human brain to perform rapid processing on input information, and may further perform continuous self-learning. Applications such as intelligent cognition of the electronic device 100 may be implemented through the NPU, for example, image recognition, facial recognition, speech recognition, and text understanding.

The interface 120 for external memory may be configured to connect to an external storage card such as a micro SD card, to extend a storage capability of the electronic device 100. The external storage card communicates with the processor 110 through the interface 120 for external memory, to implement a data storage function. For example, files such as music and videos are stored in the external storage card.

The internal memory 121 may be configured to store computer-executable program code. The executable program code includes instructions. The internal memory 121 may include a program storage area and a data storage area. The program storage area may store an operating system, an application required by at least one function (for example, a voice playing function or an image playing function), and the like. The data storage area may store data (such as audio data and an address book) created during use of the electronic device 100, and the like. In addition, the internal memory 121 may include a high-speed random access memory, or may include a nonvolatile memory, for example, at least one magnetic disk storage device, a flash memory, or a universal flash storage (UFS). The processor 110 runs instructions stored in the internal memory 121 and/or instructions stored in the memory disposed in the processor, to perform various function applications and data processing of the electronic device 100.

The pressure sensor 160A is configured to sense a pressure signal, and can convert the pressure signal into an electrical signal. In some embodiments, the pressure sensor 160A may be disposed on the display 190. There are many types of pressure sensors 160A, such as a resistive pressure sensor, an inductive pressure sensor, and a capacitive pressure sensor. The capacitive pressure sensor may include at least two parallel plates made of conductive materials. When a force is applied to the pressure sensor 160A, capacitance between electrodes changes. The electronic device 100 determines pressure intensity based on the change in the capacitance. When a touch operation is performed on the display 190, the electronic device 100 detects intensity of the touch operation by using the pressure sensor 160A. The electronic device 100 may also calculate a touch position based on a detection signal of the pressure sensor 160A. In some embodiments, touch operations that are performed in a same touch position but have different touch operation intensity may correspond to different operation instructions. For example, when a touch operation whose touch operation intensity is less than a first pressure threshold is performed on an SMS message application icon, an instruction for viewing an SMS message is performed. When a touch operation whose touch operation intensity is greater than or equal to the first pressure threshold is performed on the SMS message application icon, an instruction for creating a new SMS message is performed.

The gyroscope sensor 160B may be configured to determine a motion posture of the electronic device 100. In some embodiments, angular velocities of the electronic device 100 around three axes (namely, x, y, and z axes) may be determined through the gyroscope sensor 160B. The gyroscope sensor 160B may be configured to implement image stabilization during shooting. For example, when a shutter is pressed, the gyroscope sensor 160B detects an angle at which the electronic device 100 jitters, calculates, based on the angle, a distance for which a lens module needs to compensate, and enables the lens to cancel the jitter of the electronic device 100 through reverse motion, to implement image stabilization. The gyroscope sensor 160B may also be used in a navigation scenario and a somatic game scenario.

The acceleration sensor 160C may detect accelerations in various directions (usually on three axes) of the electronic device 100. When the electronic device 100 is still, a magnitude and a direction of gravity may be detected. The acceleration sensor 180E may be further configured to identify a posture of the electronic device, and is used in an application such as switching between a landscape mode and a portrait mode or a pedometer.

The ambient light sensor 160E is configured to sense luminance of ambient light (which may also be referred to as an environmental illumination). The electronic device 100 may adaptively adjust a brightness of the display 190 based on sensed luminance of ambient light. The ambient light sensor 160E may also be configured to automatically adjust white balance during photographing. The touch sensor 160D is also referred to as a “touch component”. The touch sensor 160D may be disposed on the display 190, and the touch sensor 160D and the display 190 form a touchscreen, which is also referred to as a “touch screen”. The touch sensor 160D is configured to detect a touch operation performed on or near the touch sensor. The touch sensor may transfer a detected touch operation to the application processor, to determine a touch event type. A visual output related to the touch operation may be provided on the display 190. In some other embodiments, the touch sensor 160D may be also disposed on a surface of the electronic device 100 at a position different from a position of the display 190.

The button 170 includes a power-on button, a volume button, and the like. The button 170 may be a mechanical button, or may be a touch button. The electronic device 100 may receive a button input, and generate a button signal input related to a user setting and function control of the electronic device 100.

A software system of the electronic device 100 may use a layered architecture, an event-driven architecture, a microkernel architecture, a micro service architecture, or a cloud architecture. For example, the software system of the electronic device 100 may use an Android operating system (OS), a Harmony operating system (OS), or an iOS with the layered architecture. In this embodiment of this application, an Android system with a layered architecture is used as an example to describe the software structure of the electronic device 100.

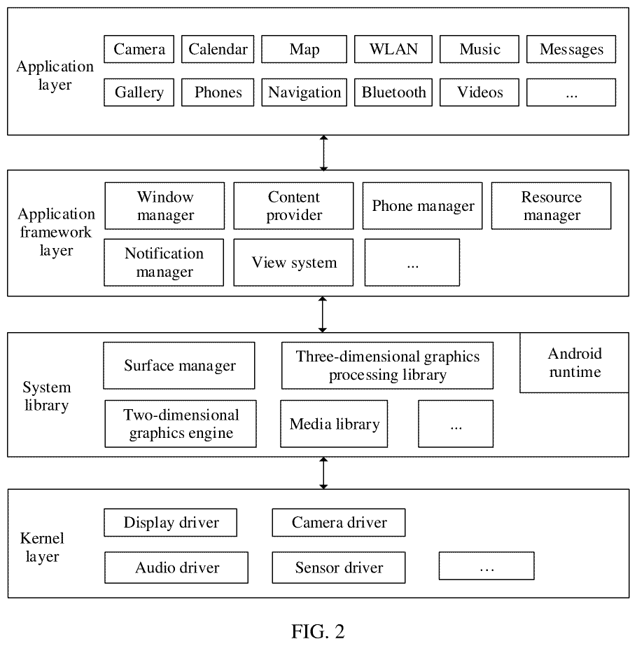

FIG. 2 is a block diagram of the software structure of the electronic device 100 according to an embodiment of this application.

In a layered architecture, software is divided into several layers, and each layer has a clear role and task. The layers communicate with each other through a software interface. In some embodiments, the Android system is divided into four layers: an application layer, an application framework layer, an Android runtime and system library, and a kernel layer from top to bottom.

The application layer may include a series of application packages.

As shown in FIG. 2, an application package may include applications such as Camera, Gallery, Calendar, Phones, Map, Navigation, WLAN, Bluetooth, Music, Videos, and Messages.

The application framework layer provides an application programming interface (API) and a programming framework for an application at the application layer. The application framework layer includes some predefined functions.

As shown in FIG. 2, the application framework layer may include a window manager, a content provider, a view system, a phone manager, a resource manager, a notification manager, and the like.

The window manager is configured to manage a window program. The window manager may obtain a size of the display, determine whether there is a status bar, perform screen locking, take a screenshot, and the like.

The content provider is configured to store and obtain data, and enable the data to be accessed by an application. The data may include a video, an image, an audio, calls that are made and answered, a browsing history, a bookmark, an address book, and the like.

The view system includes visual controls such as a control for displaying a text and a control for displaying an image. The view system may be used to construct an application. A display interface may include one or more views, for example, include a display interface of a message notification icon, and may include a view for displaying a text and a view for displaying an image.

The phone manager is used to provide a communication function of the electronic device 100, for example, management of a call status (including answering, hanging up, or the like).

The resource manager provides various resources such as a localized character string, an icon, an image, a layout file, and a video file for an application.

The notification manager enables an application to display notification information in a status bar, and may be used to convey a notification type message. The message may automatically disappear after a short pause without user interaction. For example, the notification manager is used to notify download completion, give a message notification, and the like. The notification manager may alternatively be a notification that appears in a top of a status bar in a system in a form of a graph or a scroll bar text, for example, a notification of an application running in a background or a notification that appears on a screen in a form of a dialog window. For example, text information is prompted in the status bar, an alert tone is made, the electronic device vibrates, or an indicator blinks.

The Android runtime includes a core library and a virtual machine. The Android runtime is used to schedule and manage the Android system.

The core library includes two parts: a function that needs to be called in java language and a core library of Android.

The application layer and the application framework layer run on the virtual machine. The virtual machine executes java files of the application layer and the application framework layer as binary files. The virtual machine is used to implement functions such as object lifecycle management, stack management, thread management, security and exception management, and garbage collection.

The system library may include a plurality of functional modules, for example, a surface manager, a media library, a three-dimensional graphics processing library (for example, OpenGL ES), and a 2D graphics engine (for example, SGL).

The surface manager is used to manage a display subsystem and provide fusion of 2D and 3D layers for a plurality of applications.

The media library supports playing and recording in a plurality of commonly used audio and video formats, static image files, and the like. The media library may support a plurality of audio and video coding formats such as MPEG 4, H.264, MP3, AAC, AMR, JPG, and PNG.

The three-dimensional graphics processing library is used to implement three-dimensional graphics drawing, image rendering, composition, layer processing, and the like.

The 2D graphics engine is a drawing engine for 2D drawing.

The kernel layer is a layer between hardware and software. The kernel layer includes at least a display driver, a camera driver, an audio driver, and a sensor driver.

The following describes in detail the image display method provided in embodiments of this application with reference to the accompanying drawings and specific application scenarios.

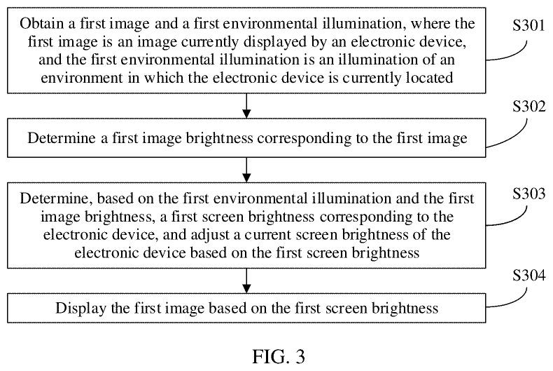

FIG. 3 is a schematic flowchart of an image display method according to an embodiment of this application. The method may be applied to an electronic device. The electronic device may be an electronic device with a display, like a mobile phone, a tablet computer, a smart TV, or a notebook computer. As shown in FIG. 3, the method may include the following steps.

S301: Obtain a first image and a first environmental illumination, where the first image is an image currently displayed by the electronic device, and the first environmental illumination is an illumination of an environment in which the electronic device is currently located.

It should be understood that the first image may include an image currently displayed by the electronic device, or may include an image to be subsequently displayed on the electronic device.

For example, a photosensitive component like as an ambient light sensor may be disposed on the electronic device, and the ambient light sensor may be configured to detect an environmental illumination around the electronic device. The electronic device may obtain the environmental illumination detected by the ambient light sensor, and obtain the first environmental illumination based on the environmental illumination detected by the ambient light sensor.

In a possible implementation, the electronic device may obtain an environmental illumination detected by the ambient light sensor at a moment, and may determine the environmental illumination at the moment as the first environmental illumination.

In another possible implementation, the ambient light sensor may obtain, according to a fixed sampling frequency, an environmental illumination of an environment in which the electronic device is currently located, to obtain a plurality of environmental illuminations. The electronic device may perform weighted averaging on the plurality of environmental illuminations, to obtain the first environmental illumination. It should be understood that the sampling frequency may be specifically determined based on an actual scenario. This is not limited in this embodiment of this application.

Optionally, a condition for triggering performing S301 by the electronic device may be a display of the electronic device is displaying content, or the electronic device receives a touch instruction of a user, or the electronic device determines that an environment in which the electronic device is located changes, or the like. The touch instruction may be an instruction generated after the electronic device detects a touch operation performed by the user on the display.

S302: Determine a first image brightness corresponding to the first image.

It may be understood that the first image brightness corresponding to the first image may be a brightness perceived by the user when the user views the first image displayed by the electronic device.

Optionally, the first image brightness corresponding to the first image may be related to the illumination (namely, the first environmental illumination) of the environment in which the electronic device is currently located, a peak brightness of the display of the electronic device, a gray scale corresponding to the first image, an angle at which the user views the first image, and the like. In other words, the electronic device may determine, based on the first environmental illumination, the peak brightness of the display of the electronic device, the gray scale corresponding to the first image, the angle at which the user views the first image, and the like, the first image brightness corresponding to the first image.

The gray scale corresponding to the first image may be determined based on an average pixel level (APL) corresponding to the first image. For example, the APL corresponding to the first image may be determined as the gray scale corresponding to the first image. The peak brightness of the display of the electronic device may be determined based on attribute information of the electronic device, and the like.

It should be noted that a manner of determining the APL corresponding to the first image is not limited in this embodiment of this application, and may be specifically determined based on an actual application scenario. For example, the electronic device may obtain a gray scale histogram corresponding to the first image, and may determine, based on the gray scale histogram, the APL corresponding to the first image.

In addition, in this embodiment of this application, a specific manner in which the electronic device determines, based on the first environmental illumination, the peak brightness of the display of the electronic device, the gray scale corresponding to the first image, the angle at which the user views the first image, and the like, the first image brightness corresponding to the first image may be any existing determining manner. This is not limited in this embodiment of this application.

S303: Determine, based on the first environmental illumination and the first image brightness, a first screen brightness corresponding to the electronic device, and adjust a current screen brightness of the electronic device based on the first screen brightness.

In this embodiment of this application, a unit of the environmental illumination may be lux (Lux), a unit of the screen brightness may be nits (nits), and the image brightness may be a value of a brightness perceived by the user, which may not have a unit.

It should be understood that, to ensure that the user has a same subjective feeling for content displayed on the display of the electronic device in different environments, the electronic device may determine, based on the first environmental illumination and the first image brightness corresponding to the first image, the first screen brightness corresponding to the electronic device, and may adjust the current screen brightness of the electronic device based on the first screen brightness, so that the user has the same subjective feeling for same content (namely, the first image) displayed on the electronic device in different environments, thereby improving user experience.

Optionally, a correspondence (which may be referred to as a first correspondence below) between an image brightness and a screen brightness under different environmental illuminations may be set in the electronic device. Therefore, the electronic device may determine the first screen brightness corresponding to the electronic device based on the first environmental illumination, the first image brightness, and the first correspondence, and adjust the current screen brightness of the electronic device based on the first screen brightness, so that a same image has same display effect in different environments, thereby improving user experience. The environmental illumination and the first correspondence between the image brightness and the screen brightness may be determined based on a light sensing characteristic of a human eye.

In an example, the environmental illumination and the first correspondence between the image brightness and the screen brightness may be represented through a curve.

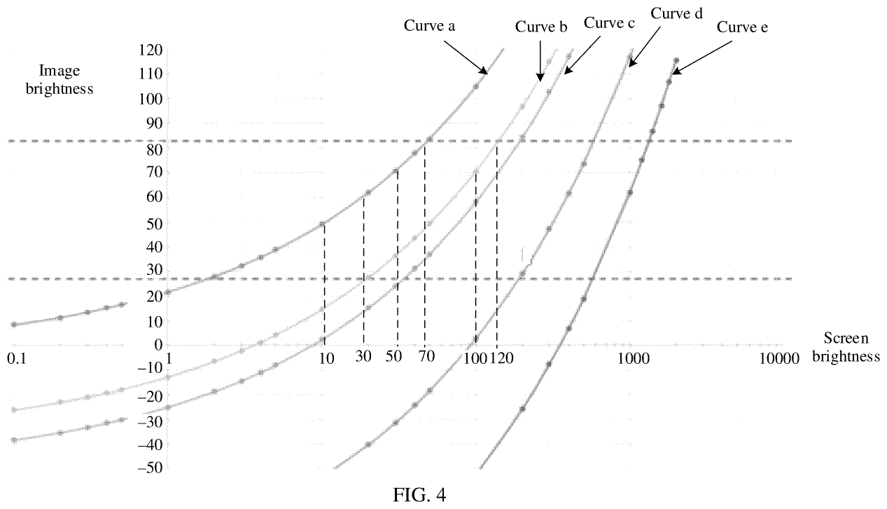

For example, FIG. 4 is an example diagram of a first correspondence according to an embodiment of this application. In this example diagram, an example in which the environmental illumination includes 0 lux, 300 lux, 800 lux, 10,000 lux, and 40,000 lux, and the first correspondence is represented through a curve is used for description.

It should be understood that a representation manner of the first correspondence, and an amount and a value of the environmental illumination in the first correspondence are not limited in this embodiment of this application, and may be specifically determined based on an actual application scenario. For example, the environmental illumination may include 0 lux, 300 lux, 500 lux, 800 lux, 2000 lux, 5000 lux, 10,000 lux, 20,000 lux, 40,000 lux, and the like based on an actual scenario.

As shown in FIG. 4, when the environmental illumination is 0 lux, the first correspondence between the image brightness and the screen luminance may be a curve a, when the environmental illumination is 300 lux, the first correspondence between the image brightness and the screen brightness may be a curve b, when the environmental illumination is 800 lux, the first correspondence between the image brightness and the screen brightness may be a curve c, when the environmental illumination is 10,000 lux, the first correspondence between the image brightness and the screen brightness may be a curve d, and when the environmental illumination is 40,000 lux, the first correspondence between the image brightness and the screen brightness may be a curve e.

In FIG. 4, a horizontal axis is the screen brightness, and a vertical axis is the image brightness.

As shown in the curve a, when the first environmental illumination is 0 lux, if the first image brightness is 80, it may be determined that the first screen brightness corresponding to the electronic device is 70 nits. In other words, in an environment of 0 lux, the screen brightness of the electronic device is adjusted to 70 nits, so that the first image brightness corresponding to the first image displayed by the electronic device is 80. If the first image brightness is 70, it may be determined that the first screen brightness corresponding to the electronic device is 50 nits. In other words, in an environment of 0 lux, the screen brightness of the electronic device is adjusted to 50 nits, so that the first image brightness corresponding to the first image displayed by the electronic device is 70. If the first image brightness is 60, it may be determined that the first screen brightness corresponding to the electronic device is 30 nits. In other words, in an environment of 0 lux, the screen brightness of the electronic device is adjusted to 30 nits, so that the first image brightness corresponding to the first image displayed by the electronic device is 60. If the first image brightness is 50, it may be determined that the first screen brightness corresponding to the electronic device is 10 nits. In other words, in an environment of 0 lux, the screen brightness of the electronic device is adjusted to 10 nits, so that the first image brightness corresponding to the first image displayed by the electronic device is 50. Another example is not described.

As shown in the curve b, when the first environmental illumination is 300 lux, if the first image brightness is 80, it may be determined that the first screen brightness corresponding to the electronic device is 120 nits. In other words, in an environment of 300 lux, the screen brightness of the electronic device is adjusted to 120 nits, so that the first image brightness corresponding to the first image displayed by the electronic device is 80. If the first image brightness is 70, it may be determined that the first screen brightness corresponding to the electronic device is 100 nits. In other words, in an environment of 300 lux, the screen brightness of the electronic device is adjusted to 100 nits, so that the first image brightness corresponding to the first image displayed by the electronic device is 70. If the first image brightness is 60, it may be determined that the first screen brightness corresponding to the electronic device is 85 nits. In other words, in an environment of 300 lux, the screen brightness of the electronic device is adjusted to 85 nits, so that the first image brightness corresponding to the first image displayed by the electronic device is 60. If the first image brightness is 50, it may be determined that the first screen brightness corresponding to the electronic device is 75 nits. In other words, in an environment of 300 lux, the screen brightness of the electronic device is adjusted to 75 nits, so that the first image brightness corresponding to the first image displayed by the electronic device is 50. Another example is not described.

As shown in the curve c, when the first environmental illumination is 800 lux, if the first image brightness is 80, it may be determined that the first screen brightness corresponding to the electronic device is 150 nits. In other words, in an environment of 800 lux, the screen brightness of the electronic device is adjusted to 150 nits, so that the first image brightness corresponding to the first image displayed by the electronic device is 80. If the first image brightness is 70, it may be determined that the first screen brightness corresponding to the electronic device is 120 nits. In other words, in an environment of 800 lux, the screen brightness of the electronic device is adjusted to 120 nits, so that the first image brightness corresponding to the first image displayed by the electronic device is 70. If the first image brightness is 60, it may be determined that the first screen brightness corresponding to the electronic device is 102 nits. In other words, in an environment of 800 lux, the screen brightness of the electronic device is adjusted to 102 nits, so that the first image brightness corresponding to the first image displayed by the electronic device is 60. If the first image brightness is 50, it may be determined that the first screen brightness corresponding to the electronic device is 90 nits. In other words, in an environment of 800 lux, the screen brightness of the electronic device is adjusted to 90 nits, so that the first image brightness corresponding to the first image displayed by the electronic device is 50. Another example is not described.

As shown in the curve d, when the first environmental illumination is 10,000 lux, if the first image brightness is 80, it may be determined that the first screen brightness corresponding to the electronic device is 800 nits. In other words, in an environment of 10,000 lux, the screen brightness of the electronic device is adjusted to 800 nits, so that the first image brightness corresponding to the first image displayed by the electronic device is 80. If the first image brightness is 70, it may be determined that the first screen brightness corresponding to the electronic device is 700 nits. In other words, in an environment of 10,000 lux, the screen brightness of the electronic device is adjusted to 700 nits, so that the first image brightness corresponding to the first image displayed by the electronic device is 70. If the first image brightness is 60, it may be determined that the first screen brightness corresponding to the electronic device is 600 nits. In other words, in an environment of 10,000 lux, the screen brightness of the electronic device is adjusted to 600 nits, so that the first image brightness corresponding to the first image displayed by the electronic device is 60. If the first image brightness is 50, it may be determined that the first screen brightness corresponding to the electronic device is 500 nits. In other words, in an environment of 10,000 lux, the screen brightness of the electronic device is adjusted to 500 nits, so that the first image brightness corresponding to the first image displayed by the electronic device is 50. Another example is not described.

As shown in the curve e, when the first environmental illumination is 40,000 lux, if the first image brightness is 80, it may be determined that the first screen brightness corresponding to the electronic device is 1500 nits. In other words, in an environment of 40,000 lux, the screen brightness of the electronic device is adjusted to 1500 nits, so that the first image brightness corresponding to the first image displayed by the electronic device is 80. If the first image brightness is 70, it may be determined that the first screen brightness corresponding to the electronic device is 1200 nits. In other words, in an environment of 40,000 lux, the screen brightness of the electronic device is adjusted to 1200 nits, so that the first image brightness corresponding to the first image displayed by the electronic device is 70. If the first image brightness is 60, it may be determined that the first screen brightness corresponding to the electronic device is 1000 nits. In other words, in an environment of 40,000 lux, the screen brightness of the electronic device is adjusted to 1000 nits, so that the first image brightness corresponding to the first image displayed by the electronic device is 60. If the first image brightness is 50, it may be determined that the first screen brightness corresponding to the electronic device is 900 nits. In other words, in an environment of 40,000 lux, the screen brightness of the electronic device is adjusted to 900 nits, so that the first image brightness corresponding to the first image displayed by the electronic device is 50. Another example is not described.

In other words, when the first image brightness corresponding to the first image needs to be ensured to be 80, if the first environmental illumination is 0 lux, the screen brightness of the electronic device needs to be adjusted to 70 nits, if the first environmental illumination is 300 lux, the screen brightness of the electronic device needs to be adjusted to 120 nits, if the first environmental illumination is 800 lux, the screen brightness of the electronic device needs to be adjusted to 150 nits, if the first environmental illumination is 10,000 lux, the screen brightness of the electronic device needs to be adjusted to 800 nits, and if the first environmental illumination is 40,000 lux, the screen brightness of the electronic device needs to be adjusted to 1500 nits.

When the first image brightness corresponding to the first image needs to be ensured to be 70, if the first environmental illumination is 0 lux, the screen brightness of the electronic device needs to be adjusted to 50 nits, if the first environmental illumination is 300 lux, the screen brightness of the electronic device needs to be adjusted to 100 nits, if the first environmental illumination is 800 lux, the screen brightness of the electronic device needs to be adjusted to 120 nits, if the first environmental illumination is 10,000 lux, the screen brightness of the electronic device needs to be adjusted to 700 nits, and if the first environmental illumination is 40,000 lux, the screen brightness of the electronic device needs to be adjusted to 1200 nits.

When the first image brightness corresponding to the first image needs to be ensured to be 60, if the first environmental illumination is 0 lux, the screen brightness of the electronic device needs to be adjusted to 30 nits, if the first environmental illumination is 300 lux, the screen brightness of the electronic device needs to be adjusted to 85 nits, if the first environmental illumination is 800 lux, the screen brightness of the electronic device needs to be adjusted to 102 nits, if the first environmental illumination is 10,000 lux, the screen brightness of the electronic device needs to be adjusted to 600 nits, and if the first environmental illumination is 40,000 lux, the screen brightness of the electronic device needs to be adjusted to 1000 nits.

When the first image brightness corresponding to the first image needs to be ensured to be 50, if the first environmental illumination is 0 lux, the screen brightness of the electronic device needs to be adjusted to 10 nits, if the first environmental illumination is 300 lux, the screen brightness of the electronic device needs to be adjusted to 75 nits, if the first environmental illumination is 800 lux, the screen brightness of the electronic device needs to be adjusted to 90 nits, if the first environmental illumination is 10,000 lux, the screen brightness of the electronic device needs to be adjusted to 500 nits, and if the first environmental illumination is 40,000 lux, the screen brightness of the electronic device needs to be adjusted to 900 nits.

In a possible implementation, after the first environmental illumination is determined, if it is determined that the first correspondence does not include an environmental illumination that is the same as the first environmental illumination, the electronic device may determine an environmental illumination (which may be referred to as an environmental illumination A below) that is closest to the first environmental illumination in environmental illuminations included in the first correspondence, and may determine the first screen brightness corresponding to the electronic device based on the environmental illumination A, the first image brightness, and the first correspondence.

It may be understood that the closest environmental illumination A may be an environmental illumination that is in all environmental illuminations included in the first correspondence and that is with a smallest absolute value of a difference from the first environmental illumination.

For example, in the application scenario shown in FIG. 4, when the first environmental illumination is 789 lux, the electronic device may determine that there is no environmental illumination that is the same as the first environmental illumination (namely, 789 lux) in environmental illuminations included in the first correspondence. In this case, the electronic device may determine the environmental illumination A that is closest to the first environmental illumination in the environmental illuminations included in the first correspondence, that is, determine that the environmental illumination A is 800 lux. Assuming that the first image brightness corresponding to the first image is 80 nits, the electronic device may determine, based on the environmental illumination A (namely, 800 lux), the first image brightness (namely, 80 nits), and the first correspondence (namely, the curve c), that the first screen brightness corresponding to the electronic device is 150 nits. In other words, when the first environmental illumination is 789 lux, if the screen brightness of the electronic device is adjusted to 150 nits, the first image brightness corresponding to the first image currently displayed by the electronic device may be close to 80 nits.

For example, in the application scenario shown in FIG. 4, when detecting that the first environmental illumination is 9000 lux, the electronic device may determine that there is no environmental illumination that is the same as the first environmental illumination (namely, 9000 lux) in environmental illuminations included in the first correspondence. In this case, the electronic device may determine an environmental illumination A that is closest to the first environmental illumination in the environmental illuminations included in the first correspondence, that is, determine that the environmental illumination A is 10,000 lux. Assuming that the first image brightness corresponding to the first image is 70 nits, the electronic device may determine, based on the environmental illumination A (namely, 10,000 lux), the first image brightness (namely, 70 nits), and the first correspondence (namely, the curve d), that the first screen brightness corresponding to the electronic device is 700 nits. In other words, when the first environmental illumination is 9000 lux, if the screen brightness of the electronic device is adjusted to 700 nits, the first image brightness corresponding to the first image currently displayed by the electronic device may be close to 70 nits.

It should be noted that the first correspondence stored in the electronic device is merely an example for explanation, and should not be construed as a limitation on embodiments of this application. In embodiments of this application, the first correspondence may also be stored in another device communicating with the electronic device, for example, stored in a cloud communicating with the electronic device, or stored in another electronic device communicating with the electronic device.

In this embodiment of this application, after determining the first screen brightness based on the first correspondence, the electronic device may adjust a current screen brightness of the electronic device based on the first screen brightness, to ensure that the user has a same subjective feeling for the first image in different environments, thereby improving user experience.

It may be understood that the screen brightness may include a backlight brightness of the electronic device and a gray scale brightness of the first image. In other words, the current screen brightness of the electronic device may be a combination of a current backlight brightness of the electronic device and a current gray scale brightness of the first image. Adjusting a system gamma value gamma of the electronic device may be adjusting the gray scale brightness of the first image. Therefore, after determining the first screen brightness corresponding to the electronic device, the electronic device may adjust at least one of the current backlight brightness and the system gamma of the electronic device based on the first screen brightness, to adjust the current screen brightness of the electronic device.

For example, the electronic device may adjust the current backlight brightness of the electronic device based on the first screen brightness. For example, the electronic device may adjust the system gamma of the electronic device based on the first screen brightness. For example, the electronic device may adjust the current backlight brightness and the system gamma of the electronic device based on the first screen brightness. Specifically, content of adjusting the backlight brightness and the system gamma of the electronic device based on the first screen brightness may be determined based on an actual scenario. This is not limited in this embodiment of this application.

For example, when the first screen brightness is greater than a maximum value of the backlight brightness of the electronic device, the electronic device may adjust the current backlight brightness of the electronic device to the maximum value of the backlight brightness, to display the first image based on the maximum value of the backlight brightness. Similarly, when the first screen brightness is less than a minimum value of the backlight brightness of the electronic device, the electronic device may adjust the current backlight brightness of the electronic device to the minimum value of the backlight brightness, to display the first image based on the minimum value of the backlight brightness. In other words, limited by hardware constraints of the display, the maximum value and the minimum value of the backlight brightness may be set in the electronic device, so that the backlight brightness of the electronic device is not greater than the maximum value, or the backlight brightness of the electronic device is not less than the minimum value.

After the backlight brightness of the electronic device is adjusted to the maximum backlight brightness, if the current screen brightness of the electronic device is still less than the first screen brightness, the electronic device may adjust the system gamma based on the first screen brightness and the current screen brightness of the electronic device, to adjust the screen brightness of the electronic device. Similarly, after the backlight brightness of the electronic device is adjusted to the minimum backlight brightness, if the current screen brightness of the electronic device is still greater than the first screen brightness, the electronic device may adjust the system gamma based on the first screen brightness and the current screen brightness of the electronic device, to adjust the screen brightness of the electronic device.

For example, when the first image has an area (for example, a face area) whose brightness needs to be adjusted, the electronic device may adjust the system gamma of the electronic device based on the first screen brightness, or may adjust the current backlight brightness of the electronic device and the system gamma of the electronic device based on the first screen brightness.

It should be understood that a manner in which the electronic device adjusts the system gamma based on the first screen brightness or based on the first screen brightness and the current screen brightness of the electronic device is not limited in this embodiment of this application, and may be determined based on an actual scenario.

Optionally, the electronic device may gradually adjust the current backlight brightness of the electronic device to the first screen brightness based on an adjustment step, or gradually adjust the current backlight brightness of the electronic device to the maximum value of the backlight brightness, or gradually adjust the current backlight brightness of the electronic device to the minimum value of the backlight brightness, to adjust the screen brightness of the electronic device without user awareness. The adjustment step may be specifically determined based on an actual scenario. This is not limited in this embodiment of this application.

S304: Display the first image based on the first screen brightness.

It should be understood that after adjusting the current screen brightness of the electronic device based on the first screen brightness, the electronic device may display the first image based on the adjusted screen brightness, so that the user have a same subjective feeling for the first image in different environments, thereby improving user experience.

In a possible implementation, the electronic device may further adjust a color saturation of the first image based on the first environmental illumination, so that the color saturation of the first image displayed by the electronic device is the same in different environments. In this way, subjective feelings of the user viewing the first image are the same in different environments, and user experience is improved.

For example, the electronic device may determine, based on the first environmental illumination, a color compensation coefficient corresponding to the first image, and may adjust the color saturation of the first image based on the color compensation coefficient. For example, the electronic device may determine a final color saturation of the first image based on the color compensation coefficient and a current color saturation of the first image, and adjust the color saturation of the first image based on the final color saturation of the first image, to adjust the color saturation of the first image to the final color saturation.

It should be understood that the manner of adjusting the color saturation of the first image based on the color compensation coefficient is merely an example for explanation, and should not be understood as a limitation on embodiments of this application. Embodiments of this application may determine a color saturation adjustment manner based on a specific application scenario.

Optionally, the electronic device may store a correspondence (which may be referred to as a second correspondence below) between environmental illumination, screen reflectance, and screen color gamut. The screen reflectance may indicate a degree of reflecting light by the display of the electronic device. Different electronic devices may have different screen reflectances, or may have a same screen reflectance. The second correspondence may be determined in advance by measuring impact of different environmental illuminations on the screen color gamut corresponding to the electronic device at different screen reflectances.

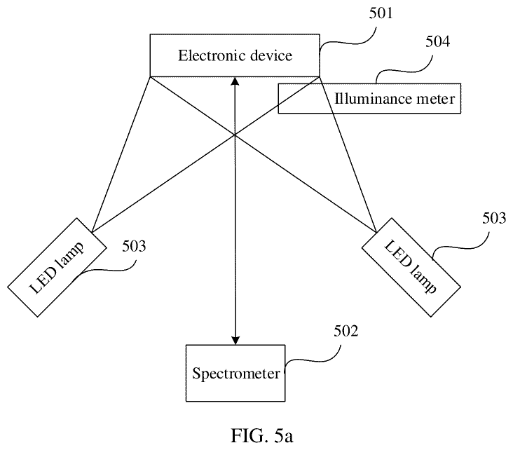

For example, FIG. 5a is an example diagram of testing a screen color gamut according to an embodiment of this application.

As shown in FIG. 5a, for an electronic device 501 with different screen reflectances, a spectrometer 502 may be used to obtain screen color gamuts corresponding to the electronic device under different illuminations of an LED lamp 503, to determine a second correspondence between an environmental illumination, a screen reflectance, and a screen color gamut. The illumination of the LED lamp 503 may be measured by using an illuminance meter 504 or the like.

Therefore, the electronic device may obtain the screen reflectivity of the electronic device, and may determine, based on the first environmental illumination, the screen reflectance, and the second correspondence, a first screen color gamut corresponding to the electronic device. Subsequently, the electronic device may determine, based on the first screen color gamut and a second screen color gamut, a color compensation coefficient corresponding to the first image, to compensate for a color saturation of the first image based on the color compensation coefficient. The second screen color gamut may be a screen color gamut corresponding to the electronic device in a second environmental illumination. In other words, the second screen color gamut may be determined based on the second environmental illumination, the screen reflectance, and the second correspondence.

Optionally, the second environmental illumination is different from the first environmental illumination. In other words, the second environmental illumination and the first environmental illumination may be illuminations in different environments. The second environmental illumination may be an illumination of an environment in which the electronic device is located before a use environment of the electronic device is switched to a current environment. For example, when the use environment of the electronic device is switched from an environment A (for example, an indoor environment) to an environment B (for example, an outdoor environment), the first environmental illumination may be an illumination of the environment B, and the second environmental illumination may be an illumination of the environment A. In this way, a color saturation of the first image is compensated based on an illumination of the environment in which the electronic device is located before switching and an illumination of the environment in which the electronic device is currently located, to ensure that the user has a consistent subjective feeling for the first image in different environments, thereby improving user experience.

It should be understood that the color gamut may indicate a range of colors that can be displayed by the display of the electronic device. A larger color gamut indicates that the electronic device can display more colors, and a smaller color gamut indicates that the electronic device can display fewer colors. There are three common color gamut standards: sRGB, NTSC, and AdobeRGB.

Optionally, the electronic device may determine, based on color compensation coefficient=second screen color gamut/first screen color gamut, a color compensation coefficient corresponding to the first image.

For example, sRGB is used as an example. When the first screen color gamut is 80% sRGB and the second screen color gamut is 90% sRGB, the electronic device may determine that the color compensation coefficient corresponding to the first image is 1.125.

For example, when the first screen color gamut is 80% sRGB and the second screen color gamut is 100% sRGB, the electronic device may determine that the color compensation coefficient corresponding to the first image is 1.25.

In this embodiment of this application, the screen color gamut corresponding to the electronic device is an observable color gamut corresponding to the electronic device. The observable color gamut is a range of colors that can be observed on the display of the electronic device under an environmental illumination. In other words, the first screen color gamut corresponding to the electronic device is a range of colors that can be observed on the display of the electronic device under the first environmental illumination. The second screen color gamut corresponding to the electronic device is a range of colors that can be observed on the display of the electronic device under the second environmental illumination.

FIG. 5b is an example diagram of a screen color gamut according to an embodiment of this application. In the example diagram, a dashed line area may be a color area range corresponding to a color gamut standard, for example, may be a color area range corresponding to sRGB, NTSC, or AdobeRGB. Different triangular areas may be observable color gamuts corresponding to the electronic device under different environmental illuminations.

As shown in FIG. 5b, for a same electronic device, observable color gamuts corresponding to the electronic device are different under different environmental illuminations. For the same electronic device, when the environmental illumination is higher, the observable color gamut corresponding to the electronic device is smaller.

It should be understood that, for electronic devices with different screen reflectances, observable color gamuts corresponding to the electronic devices are different under a same environmental illumination. Specifically, under a same environmental illumination, a lower screen reflectance indicates a larger observable color gamut corresponding to the electronic device.

It should be noted that the second correspondence stored in the electronic device is merely an example for explanation, and should not be construed as a limitation on embodiments of this application. In embodiments of this application, the second correspondence may also be stored in another device communicating with the electronic device, for example, may be stored in a cloud or another electronic device communicating with the electronic device.

In an example, after determining the color compensation coefficient corresponding to the first image based on the first screen color gamut and the second screen color gamut, the electronic device may determine whether the first image is over-saturated when the color compensation coefficient is used to compensate for the color saturation of the first image. When the first image is over-saturated, for example, after the color saturation of the first image is compensated based on the color compensation coefficient, if a pixel value of a pixel in the compensated first image is greater than 255, the electronic device may determine that the first image is over-saturated. In this case, the electronic device may determine a maximum pixel value in the first image, and may determine, based on the maximum pixel value in the first image and 255, a final color compensation coefficient corresponding to the first image, to compensate for the color saturation of the first image based on the final color compensation coefficient corresponding to the first image, to avoid over-saturation of the first image.

For example, the final color compensation coefficient corresponding to the first image may be 255/the maximum pixel value in the first image.

For example, when the maximum pixel value in the first image is 200, the electronic device may determine that the final color compensation coefficient corresponding to the first image is 255/200, that is, the electronic device may use 255/200 to compensate for the color saturation of the first image. For example, when the maximum pixel value in the first image is 225, the electronic device may determine that the final color compensation coefficient corresponding to the first image is 255/225. In other words, the electronic device may use 255/225 to compensate for the color saturation of the first image, and the like.

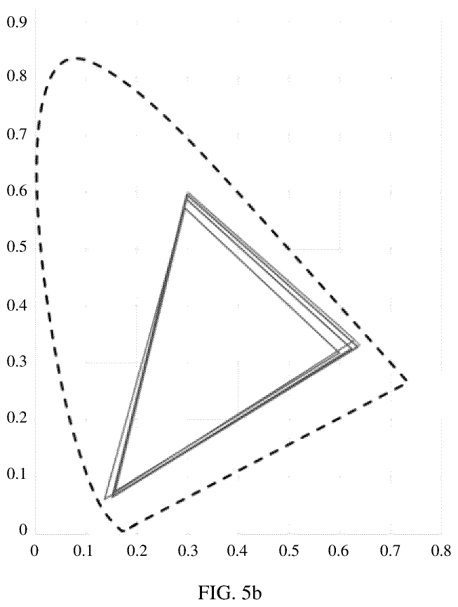

FIG. 6 is a schematic flowchart of an image display method according to another embodiment of this application. The method may be applied to an electronic device. The electronic device may be an electronic device with a display, like a mobile phone, a tablet computer, a smart TV, or a notebook computer. As shown in FIG. 6, the method may include the following steps.

S601: Obtain a first environmental illumination, where the first environmental illumination is an illumination of an environment in which the electronic device is currently located.

Specific content of S601 is similar to related content of obtaining the first environmental illumination in S301, and details are not described herein again.

S602: Determine, based on the first environmental illumination and a screen reflectance of the electronic device, a color compensation coefficient corresponding to a currently displayed first image.

It should be understood that the first image may be an image currently displayed by the electronic device, or may include an image to be displayed on the electronic device. For specific content of determining, by the electronic device, the color compensation coefficient corresponding to the first image based on the first environmental illumination and the screen reflectance of the electronic device, refer to the foregoing related content of determining the color compensation coefficient. Details are not described herein again.

For example, the electronic device may be provided with a second correspondence between an environmental illumination, a screen reflectance, and a screen color gamut. The electronic device may determine, based on the first environmental illumination, the screen reflectance of the electronic device, and the second correspondence, the first screen color gamut corresponding to the electronic device, and determine, based on the first screen color gamut and the second screen color gamut, the color compensation coefficient corresponding to the first image. The second screen color gamut is a screen color gamut corresponding to the electronic device under the second environmental illumination.

S603: Adjust a color saturation of the first image based on the color compensation coefficient, and display the first image whose color saturation is adjusted.

It should be understood that for specific content of adjusting the color saturation of the first image by the electronic device based on the color compensation coefficient, refer to the foregoing related content of color saturation adjustment. Details are not described herein again.

In an example, the electronic device may further determine first image brightness corresponding to the first image. Subsequently, the electronic device may determine a first screen brightness corresponding to the electronic device based on the first environmental illumination and the first image brightness, and may adjust a current screen brightness of the electronic device based on the first screen brightness, to display, based on an adjusted screen brightness, the first image whose color saturation is adjusted.

For specific content of determining the first image brightness corresponding to the first image and determining the first screen brightness, refer to the foregoing related content of determining the first image brightness corresponding to the first image and determining the first screen brightness. Details are not described herein again.

For example, a first correspondence between an image brightness and a screen brightness under different environmental illuminations may be set in the electronic device. The electronic device may determine, based on the first environmental illumination, the first image brightness, and the first correspondence, the first screen brightness corresponding to the electronic device.

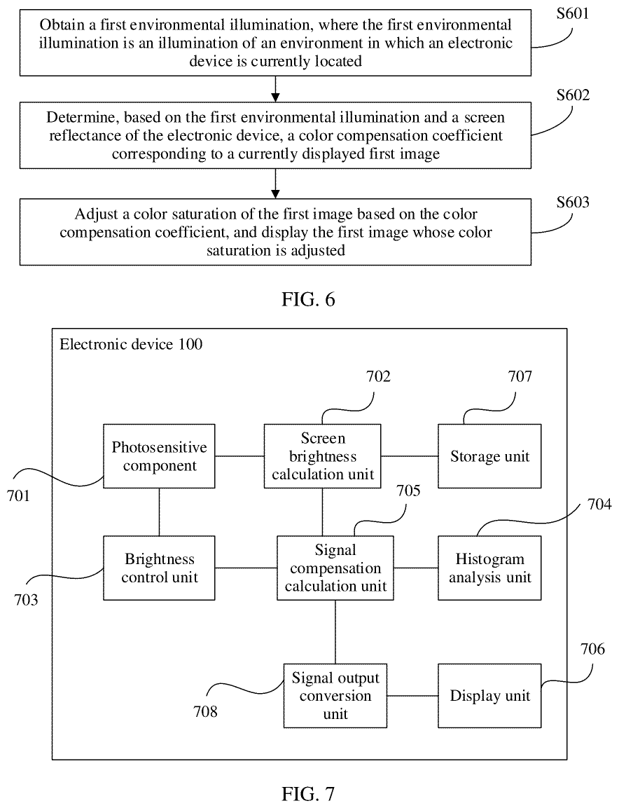

FIG. 7 is a diagram of a structure of an electronic device according to another embodiment of this application.

As shown in FIG. 7, an electronic device 100 may include a photosensitive component 701, a screen brightness calculation unit 702, a brightness control unit 703, a histogram analysis unit 704, a display unit 706, and a storage unit 707. The storage unit 707 may store a first correspondence between a screen brightness and an image brightness under different environmental illuminations.

The photosensitive component 701 may be configured to sense illumination of an environment in which the electronic device 100 is currently located, namely, a first environmental illumination. It should be understood that the photosensitive component 701 may be an ambient light sensor or the like.

The screen brightness calculation unit 702 may be configured to determine a first image brightness corresponding to a first image, and determine, based on the first environmental illumination and the first image brightness, a first screen brightness corresponding to the electronic device 100.

For example, the screen brightness calculation unit 702 may be configured to determine, based on the first environmental illumination, the first image brightness, and the first correspondence stored in the storage unit 707, the first screen brightness corresponding to the electronic device 100.

The brightness control unit 703 may be configured to control a current screen brightness of the electronic device 100 based on the first screen brightness.

The display unit 706 may be configured to display the first image. For example, the display unit 706 may be configured to display the first image at a first screen brightness.

In an example, the histogram analysis unit 704 may be configured to determine a gray scale histogram corresponding to the first image.

The screen brightness calculation unit 702 may be further configured to determine, based on the gray scale histogram corresponding to the first image, a gray scale corresponding to the first image, determine the first image brightness corresponding to the first image based on the first environmental illumination, a peak brightness of a display of the electronic device 100, the gray scale corresponding to the first image, an angle at which a user views the first image, and the like, and determine, based on the first environmental illumination and the first image brightness, the first screen brightness corresponding to the electronic device 100.

In another example, the electronic device 100 may further include a color calculation unit (not shown in FIG. 7). The storage unit 707 may further store a second correspondence between an environmental illumination, a screen reflectance, and a screen color gamut.

The color calculation unit may be configured to determine, based on the first environmental illumination, the screen reflectance of the electronic device 100, and the second correspondence stored in the storage unit 707, a first screen color gamut corresponding to the electronic device 100, that is, determine a screen color gamut of the electronic device 100 in a current environment.

The color calculation unit may be further configured to determine, based on a second environmental illumination, the screen reflectance of the electronic device 100, and the second correspondence, a second screen color gamut corresponding to the electronic device 100, that is, determine a screen color gamut of the electronic device 100 under the second environmental illumination. The second environmental illumination may be an illumination of an environment in which the electronic device 100 is located before the electronic device 100 switches to the current environment.

In an example, the electronic device 100 may further include a signal compensation calculation unit 705 and a signal output conversion unit 708.

The signal compensation calculation unit 705 may be configured to determine, based on the first screen color gamut and the second screen color gamut, a color compensation coefficient corresponding to the first image, and determine, based on the color compensation coefficient, a signal value (for example, a pixel value) of each signal (for example, a pixel) in the first image after conversion.

The signal output conversion unit 708 may be configured to convert each signal in the first image based on the signal value determined by the signal compensation calculation unit 705, and output each signal value after conversion of the first image to the display unit 706.

The display unit 706 may be further configured to display the first image based on the signal value output by the signal output conversion unit 708.

In this embodiment of this application, the electronic device may obtain the first image currently displayed by the electronic device and the first environmental illumination of the environment in which the electronic device is currently located, and may determine the first image brightness corresponding to the first image. Subsequently, the electronic device may determine a first screen brightness corresponding to the electronic device based on the first environmental illumination and the first image brightness, and may adjust a current screen brightness of the electronic device based on the first screen brightness, to display the first image based on an adjusted screen brightness. In other words, in this embodiment of this application, the screen brightness of the electronic device may be adjusted based on the first environmental illumination of the environment in which the electronic device is currently located and the first image brightness corresponding to the first image currently displayed by the electronic device, so that subjective feelings of the user viewing same content (namely, the first image) are consistent in different environments, thereby improving user experience.

It should be understood that sequence numbers of the steps do not mean an execution sequence in the foregoing embodiments. The execution sequence of the processes should be determined based on functions and internal logic of the processes, and should not constitute any limitation on the implementation processes of embodiments of this application.

Corresponding to the image display method in the foregoing embodiments, an embodiment of this application further provides an image display apparatus. Modules of the apparatus may correspondingly implement the steps of the image display method.

It should be noted that content such as information exchange and execution processes between the foregoing apparatuses/units are based on a same concept as those in the method embodiments of this application. For specific functions and brought technical effect of the foregoing apparatuses/units, refer to the method embodiments. Details are not described herein again.

Persons skilled in the art may clearly understand that, for the purpose of convenient and brief description, division into the foregoing functional units and modules is merely used as an example for description. In an actual application, the foregoing functions may be allocated to different functional units and modules for implementation based on a requirement. In other words, an inner structure of the apparatus is divided into different functional units or modules, to implement all or some of the functions described above. Functional units and modules in embodiments may be integrated into one processing unit, or each of the units may exist alone physically, or two or more units may be integrated into one unit. The integrated unit may be implemented in a form of hardware, or may be implemented in a form of a software functional unit. In addition, specific names of the functional units and modules are merely for ease of distinguishing between the functional units and modules, but are not intended to limit the protection scope of this application. For a specific working process of the units or modules in the foregoing system, refer to a corresponding process in the method embodiments. Details are not described herein again.

An embodiment of this application further provides an electronic device. The electronic device includes at least one memory, at least one processor, and a computer program that is stored in the at least one memory and that may be run on the at least one processor. When the processor executes the computer program, the electronic device is enabled to implement the steps in any one of the foregoing method embodiments. For example, a structure of the electronic device may be shown in FIG. 1.

An embodiment of this application further provides a computer-readable storage medium. The computer-readable storage medium stores a computer program. When the computer program is executed by a computer, the computer is enabled to implement the steps in any one of the foregoing method embodiments.

An embodiment of this application provides a computer program product. When the computer program product runs on an electronic device, the electronic device is enabled to implement the steps in any one of the foregoing method embodiments.

When an integrated unit is implemented in the form of a software functional unit and sold or used as an independent product, the integrated unit may be stored in a computer-readable storage medium. Based on such an understanding, in this application, all or some of the procedures of the methods in the foregoing embodiments may be implemented by a computer program instructing related hardware. The computer program may be stored in a computer-readable storage medium. When the computer program is executed by a processor, the steps in the method embodiments can be implemented. The computer program includes computer program code, and the computer program code may be in a source code form, an object code form, an executable file, an intermediate form, or the like. The computer-readable storage medium may include at least any entity or apparatus that can carry the computer program code to an apparatus/electronic device, a recording medium, a computer memory, a read-only memory (read-only memory, ROM), a random access memory (random access memory, RAM), an electrical carrier signal, a telecommunication signal, and a software distribution medium, for example, a USB flash drive, a removable hard disk, a magnetic disk, or an optical disk. In some jurisdictions, the computer-readable medium cannot be an electrical carrier signal or a telecommunication signal according to legislation and patent practices.

In the foregoing embodiments, descriptions of each embodiment have respective focuses. For a part that is not described in detail or recorded in an embodiment, refer to related descriptions in another embodiment.

Persons of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraint conditions of the technical solutions. Persons skilled in the art may use different methods to implement the described functions for each particular application, but it should not be considered that the implementation goes beyond the scope of this application.

In embodiments provided in this application, it should be understood that the disclosed apparatus/electronic device and method may be implemented in other manners. For example, the described apparatus/electronic device embodiment is merely an example. For example, division into the modules or units is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

The foregoing embodiments are merely intended to describe the technical solutions of this application, but are not to limit this application. Although this application is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of embodiments of this application, and these modifications and replacements shall fall within the protection scope of this application.

What is claimed is:

1. An image display method, applied to an electronic device, wherein the method comprises:
obtaining a first image and a first environmental illumination, wherein the first image is an image currently displayed by the electronic device, and the first environmental illumination is an illumination of an environment in which the electronic device is currently located;
determining a first image brightness corresponding to the first image;
determining a first screen brightness corresponding to the electronic device based on the first environmental illumination and the first image brightness;
adjusting a current screen brightness of the electronic device based on the first screen brightness; and
displaying the first image based on the first screen brightness.

2. The method according to claim 1, wherein the electronic device stores a first correspondence between an image brightness and a screen brightness under different environmental illuminations; and
wherein the determining the first screen brightness corresponding to the electronic device comprises:
determining the first screen brightness corresponding to the electronic device based on the first environmental illumination, the first image brightness, and the first correspondence.

3. The method according to claim 1, wherein the method further comprises:
adjusting a color saturation of the first image based on the first environmental illumination.

4. The method according to claim 3, wherein the adjusting the color saturation of the first image based on the first environmental illumination comprises:
determining a color compensation coefficient corresponding to the first image based on the first environmental illumination and a screen reflectance of the electronic device; and
adjusting the color saturation of the first image based on the color compensation coefficient.

5. The method according to claim 4, wherein the determining the color compensation coefficient corresponding to the first image comprises:
determining a first screen color gamut corresponding to the electronic device based on the first environmental illumination and the screen reflectance of the electronic device, wherein the first screen color gamut is a screen color gamut corresponding to the electronic device under the first environmental illumination;
and determining the color compensation coefficient corresponding to the first image based on the first screen color gamut and a second screen color gamut, wherein the second screen color gamut is a screen color gamut corresponding to the electronic device under a second environmental illumination.

6. The method according to claim 5, wherein the electronic device stores a second correspondence between an environmental illumination, a screen reflectance, and a screen color gamut; and
wherein the determining the first screen color gamut corresponding to the electronic device comprises:
determining the first screen color gamut corresponding to the electronic device based on the first environmental illumination, the screen reflectance, and the second correspondence.

7. The method according to claim 5, wherein the color compensation coefficient is equal to ratio of the second screen color gamut to the first screen color gamut.

8. An image display method, applied to an electronic device, wherein the method comprises:
obtaining a first environmental illumination, wherein the first environmental illumination is an illumination of an environment in which the electronic device is currently located;
determining a color compensation coefficient corresponding to a currently displayed first image based on the first environmental illumination and a screen reflectance of the electronic device;
adjusting a color saturation of the first image based on the color compensation coefficient; and
displaying the first image whose color saturation is adjusted.

9. The method according to claim 8, wherein the determining the color compensation coefficient corresponding to the currently displayed first image comprises:
determining a first screen color gamut corresponding to the electronic device, based on the first environmental illumination and the screen reflectance of the electronic device, wherein the first screen color gamut is a screen color gamut corresponding to the electronic device under the first environmental illumination; and
determining the color compensation coefficient corresponding to the first image based on the first screen color gamut and a second screen color gamut, wherein the second screen color gamut is a screen color gamut corresponding to the electronic device under a second environmental illumination.

10. The method according to claim 9, wherein the electronic device stores a second correspondence between an environmental illumination, a screen reflectance, and a screen color gamut; and
wherein the determining the first screen color gamut corresponding to the electronic device comprises:
determining the first screen color gamut corresponding to the electronic device based on the first environmental illumination, the screen reflectance, and the second correspondence.

11. An electronic device, comprising:
a photosensitive component, configured to obtain a first environmental illumination, wherein the first environmental illumination is an illumination of an environment in which the electronic device is currently located;
a display;
a processor; and
a non-transitory computer readable medium storing instructions for execution by the processor, wherein the instructions, the processor and the computer readable medium are configured to cause the electronic device to:
obtain a first image, wherein the first image is an image currently displayed by the electronic device;
determine a first image brightness corresponding to the first image;
determine a first screen brightness corresponding to the electronic device based on the first environmental illumination and the first image brightness; and
adjust a current screen brightness of the electronic device based on the first screen brightness;
cause the display to display the first image at the first screen brightness.

12. The electronic device according to claim 11, wherein the instructions, the processor and the computer readable medium are configured to further cause the electronic device to:
determine a color compensation coefficient corresponding to the first image based on the first environmental illumination and a screen reflectance of the electronic device;
adjust a color saturation of the first image based on the color compensation coefficient; and
cause the display to display, at the first screen brightness, the first image whose color saturation is adjusted.

13. The electronic device according to claim 11, wherein the electronic device stores a first correspondence between an image brightness and a screen brightness under different environmental illuminations; and
wherein the instructions, the processor and the computer readable medium are configured to further cause the electronic device to determine the first screen brightness corresponding to the electronic device based on the first environmental illumination, the first image brightness, and the first correspondence.

14. The electronic device according to claim 12, wherein the instructions, the processor and the computer readable medium are configured to further cause the electronic device to:
determine a first screen color gamut corresponding to the electronic device based on the first environmental illumination and the screen reflectance of the electronic device, wherein the first screen color gamut is a screen color gamut corresponding to the electronic device under the first environmental illumination; and
determine a color compensation coefficient corresponding to the first image based on the first screen color gamut and a second screen color gamut, wherein the second screen color gamut is a screen color gamut corresponding to the electronic device under a second environmental illumination.

15. The electronic device according to claim 14, wherein the electronic device stores a second correspondence between an environmental illumination, a screen reflectance, and a screen color gamut; and
wherein the instructions, the processor and the computer readable medium are configured to further cause the electronic device to determine the first screen color gamut corresponding to the electronic device based on the first environmental illumination, the screen reflectance, and the second correspondence.

16. The electronic device according to claim 14, wherein the color compensation coefficient equal to ratio of the second screen color gamut and the first screen color gamut.
